(19) United States
(12) Patent Application Publication
(10) Pub. No.: US 2003/0086665 A1
(43) Pub. Date: May 8, 2003

(54) High-fiber-density cable with buffer cells shaped as skewed radial sectors

(75) Inventor: Nicholas V. Nechitailo, Conover, NC (US)

Correspondence Address: SUGHRUE MION, PLLC, 2100 Pennsylvania Avenue, NW, Washington, DC, 20037-3213, US

(73) Assignee: ALCATEL

(21) Appl. No.: 09/985,920

(22) Filed: Nov. 6, 2001

(51) Int. Cl. G02B 6/44

(52) U.S. Cl. 385/110; 385/114

(57) ABSTRACT

A fiber optic cable having skewed partitions is provided. Specifically, the fiber optic cable has a jacket, having an interior surface and exterior surface. A core element is centrally located within the jacket. Partitions extend from the core element to the interior surface in a skewed manner, thereby creating buffer cells within the fiber optic cable. A plurality of fiber ribbons and/or optic fibers may be housed within the buffer cells. The buffer cells ability to rotate and move the fibers sideways under crushing loads help protect the optic fibers and fiber ribbons from being crushed. Furthermore, the buffer cells provide a unique and optimal packaging configuration for high-fiber density cables.

### FIELD OF THE INVENTION

The present invention relates to fiber optic cables and more specifically to fiber optic cables having partitions that create buffer cells for housing fiber optic ribbons.

### BACKGROUND

Optical fibers housed in fiber optic cables are typically sensitive to various stresses that, when encountered, degrade the transmission quality of the fiber optic cable. Numerous techniques for packaging optical fibers within optic cables have been developed to provide greater protection to the optical fibers. Conventional fiber optic cable packaging configurations include loose tube fiber optic cables, wherein the optical fibers are placed in buffer tubes to protect the fibers from external forces applied to the cable. One method of constructing a loose tube optical cable is to strand or wind several buffer tubes, containing the fibers, around a core element or central strength member. A jacket is then used to encase the group of buffer tubes.

Utilizing buffer tubes in a fiber optic cable, however, has numerous disadvantages. Conventionally, the objective of the loose tube construct was to protect the fibers contained in the buffer tube from stresses applied to the fiber optic cable. However, fiber stress and attenuation often result when the fibers come into contact with the buffer tube. For example, attenuation occurs when the buffer tube experiences contraction or elongation. Furthermore, when an external force is applied to the cable, specifically in a radial direction, the buffer tube and fibers may be crushed against the central strength member.

FIGS. 1a-1d depicts the effects of a crushing force on a conventional fiber optic cable 5 which includes a central strength member 9 around which buffer tubes 7, containing optical fibers (not shown), are wound. As seen in FIGS. 1a-1d, as a force is applied in a radial direction to the exterior of the fiber optic cable 5, the cable 5 is compressed into an oval shape thereby deforming the buffer tubes 7 contained therein. Furthermore, the buffer tubes 7, as depicted in FIGS. 1b-1d, are crushed against the stiff central strength member 9 when a load or force is applied to the exterior of the fiber optic cable 5. As the relatively soft buffer tubes 7 are crushed into the stiff central strength member 9, the optical fibers or fiber ribbons (not shown) contained within the buffer tube 7 are also damaged.

U.S. Pat. No 5,177,809 discloses an optical fiber cable that includes a core member with radial extending partitions between which optical fibers are housed. The problem with this arrangement is the partitions extend radially from the core element to the jacket. When a force is applied to the fiber cable, the perpendicular partitions do not provide flexibility and may buckle or collapse, thus damaging the fibers. To improve the crush resistance of the perpendicular partitions, the wall thickness of the partitions needs to be increased. This, however, reduces the space for fiber ribbons and overall fiber density per cable cross-sectional area. Thus, the prior art does not provide a fiber cable structure that effectively provides a high-fiber density cable structure that protects optical fibers against a crushing force.

In addition to providing poor protection of the optical fibers, the circular dimension of the traditional buffer tube 7 fails to provide an optimal packaging configuration for optic fibers because the circular design of the buffer tube 7 occupies vital space which may be used to house the rectangular shape of the fiber ribbon stacks. Simply put, using buffer tubes 7 to encapsulate fiber ribbons does not result in an optimal use of the cable's 5 interior space. Accordingly, because the buffer tube 7 space is not maximized, the fiber optic cable 5 suffer from a low fiber count or an increased diameter.

The existing art therefore fails to provide an optical fiber housing construct that minimizes fiber optic damage and maximizes space. Thus, it would be desirable to design a new geometry for fiber optic cables that provides an optimal optic fiber housing configuration while protecting the optic fibers from crushing forces.

### SUMMARY OF THE INVENTION

In an embodiment of the invention, a fiber optic cable having skewed partitions is provided. Specifically, the fiber optic cable has a jacket, having an interior surface and exterior surface. A core element is centrally located within the jacket. Skewed partitions extend from the central core element to the interior surface, thereby creating buffer cells within the fiber optic cable. A plurality of fiber ribbons and/or optic fibers may be housed within the buffer cells. The buffer cells ability to rotate and move the fibers sideways under crushing loads helps protect the optic fibers and fiber ribbons. The buffer cells provide a unique and optimal packaging configuration for fiber ribbons because the entire dimension of the buffer cell may be utilized for housing optic fibers and fiber ribbons.

### BRIEF DESCRIPTION OF THE DRAWINGS

FIGS. 1(a)-1(d) are a sequential depiction of a sectional view of a buffer tube wherein a crushing force is applied to a buffer tube.

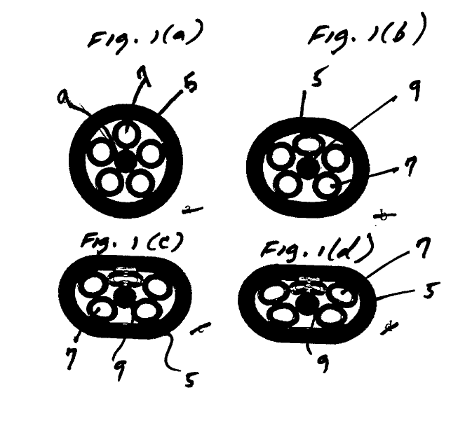

FIG. 2 is a cross sectional view of a fiber optic cable having buffer cells formed by skewed partitions.

### DETAILED DESCRIPTION

The present invention will now be fully described with reference to the accompanying drawings, wherein preferred embodiments of the invention are shown. This invention may be embodied in many different forms and should not be construed as limited to the embodiments set forth herein. Rather these embodiments are provided so that the disclosure will be thorough and complete.

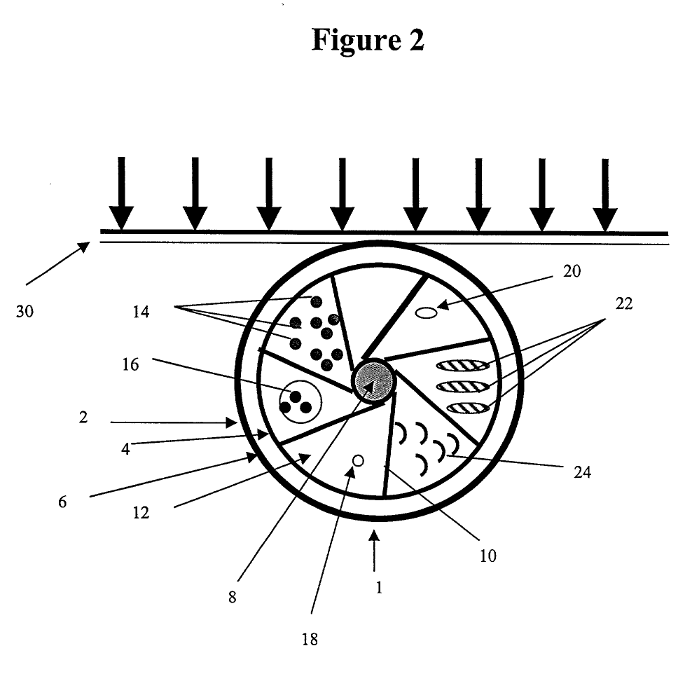

Referring now to FIG. 2, a fiber optic cable having skewed partitions that form buffer cells within a fiber optic cable is illustrated. The fiber optic cable 1 includes a jacket 2 having an interior surface 4 and an exterior surface 6. The jacket 2 may be a single layer of material such as polyethylene, polypropylene, PVC or other existing thermoplastic materials.

A core element 8, often referred to as a central strength member, is centrally located within the jacket 2. The core element 8 typically extends the length of the fiber optic cable 1 and is made of glass, reinforced plastic and other materials with a low coefficient of thermal expansion and high elastic modulus. Alternatively, slotted rods, used to carry loads (i.e. as strength members) and used to house ribbons, are also usable for the purpose of this invention.

Partitions 10 extend from the core element 8 to the interior surface 4 of the jacket 2 thereby forming buffer cells 12. More importantly, the partitions 10 extend from the core element 8 to the interior surface 4 in a skewed or slanted manner. The term skewed, as used herein, means placed at an angle with respect to a radial or diameter line of the cable passing through the geometric center of the core element. The cross-sectional geometry of the buffer cells 12 is thus shaped as skewed sectors. The partitions 10 may be made of existing thermoplastic (extrudable) materials such as polyethylene, polypropylene or PVC. Additionally, the partitions 10 may be continuations of the core element 8, (i.e. made of the same material as the core element) thus forming a slotted rod configuration. A slotted rod is a rod, having longitudinal grooves, made of a material with a high elastic modulus and strength.

Positioning the partitions 10 in a skewed fashion enhances the fiber optic cable's 1 ability to accommodate a crushing force and reduces damage to the fibers. Thus, instead of buckling and collapsing, as seen with straight radial partitions, the skewed partitions 10 will rotate and deform without collapsing or breaking. Furthermore, the cross-sectional geometry of a fiber optic cable 1, having skewed buffer cells 12, helps protect fibers against crushing loads 30 by rotational displacement of the fibers in a sideways direction.

More specifically, the skewed partitions 10 absorb strain energy by a rotational mode of deformation (like a flat elastic membrane or a flat spring element with a cantilever clamped edge configuration). The rotating partitions 10 move the fibers in a sideways direction in order to avoid crushing the fibers against the core element 8. This protective feature is especially pronounced in the case of short-term and impact loads, wherein rotating and moving, in a circumferential direction, provides time delay for the load to be transferred to the fibers.

The buffer cells 12 may house numerous components. By way of example and not limitation, the buffer cells 12 may house a bundle of optic fibers 14, fiber ribbons 16, soft cushions 20, flat ribbons 22, arched-shaped or generally non-flat ribbons 24, ripcords 18, buffer tubes, water swellable tape and strength yarns (not shown). Furthermore, the cable components listed above, such as fiber ribbons 16, may be stacked together in a buffer cell 12 to aid fiber management and fiber splicing. To further aid fiber management, the partitions 10 may be color coded to aid in the identification of optic fibers housed within a particular buffer cell.

As opposed to conventional buffer tubes, buffer cells 12 optimize space for housing optic fiber 14, fiber ribbons 16 and other components because substantially the entire area of the buffer cell 12 may be utilized to house fibers. Due to the optimal use of space provided by buffer cells 12, fiber optic cables 1 utilizing this cross-sectional geometry may have a high-fiber count and a reduced diameter and weight.

What is claimed is:

1 A fiber optic cable comprising:
a jacket having an interior jacket surface and an exterior jacket surface;
a core element centrally disposed within the jacket; and
a plurality of partitions extending from said core element to said interior surface of said jacket in a skewed direction, wherein said partitions form a plurality of buffer cells.

2. The fiber optic cable of claim 1, wherein a non-flat ribbon is housed in at least one of said buffer cells.

3. The fiber optic cable of claim 1, wherein a plurality of fiber ribbons are housed in at least one of said buffer cells.

4. The fiber optic cable of claim 1, wherein an optic fiber is housed in at least one of said buffer cells.

5. The fiber optic cable of claim 1, wherein a soft cushion is housed in at least one of said buffer cells.

6. The fiber optic cable of claim 1, wherein a ripcord is housed in at least one of said buffer cells.

7. The fiber optic cable of claim 1, wherein water swellable tape is housed in at least one of said buffer cells.

8. The fiber optic cable of claim 1, wherein a plurality of flat ribbons are housed in at least one of said buffer cells.

9. The fiber optic cable of claim 1, wherein strength yarn is housed in at least one of said buffer cells.

10. The fiber optic cable of claim 1, wherein at least one buffer tube is housed in at least one of said buffer cells.

11. The fiber optic cable of claim 1, wherein the partitions are operably configured to provide protection of the fiber ribbons against crushing forces applied to the fiber optic cable.

12. The fiber optic cable of claim 1, wherein the partitions are color coded.

13. The fiber optic cable of claim 1, wherein the skewed partitions deform without breaking or collapsing.

14. A fiber optic cable comprising:
a jacket having an interior jacket surface and an exterior jacket surface;
a core element centrally disposed within the jacket; and
a plurality of partitions extending from said core element to said interior surface of said jacket, wherein said partitions are located at an angle with respect to a radial line extending from said core element thereby forming at least one buffer cell.

15. The fiber optic cable of claim 14, wherein an arched ribbon is housed in at least one of said buffer cells.

16. The fiber optic cable of claim 14, wherein a plurality of fiber ribbons are housed in at least one of said buffer cells.

17. The fiber optic cable of claim 14, wherein an optic fiber is housed in at least one of said buffer cells.

18. The fiber optic cable of claim 14, wherein a soft cushion is housed in at least one of said buffer cells.

19. The fiber optic cable of claim 14, wherein a ripcord is housed in at least one of said buffer cells.

20. The fiber optic cable of claim 14, wherein water swellable tape is housed in at least one of said buffer cells.

21. The fiber optic cable of claim 14, wherein a plurality of flat ribbons are housed in at least one of said buffer cells.

22. The fiber optic cable of claim 14, wherein at least one buffer tube is housed in at least one of said buffer cells.

23. The fiber optic cable of claim 14, wherein strength yarn is housed in at least one of said buffer cells.

24. The fiber optic cable of claim 14, wherein the partitions are operably configured to provide protection of the fiber ribbons against crushing forces applied to the fiber optic cable.

25. The fiber optic cable of claim 14, wherein the partitions are color coded.

26. The fiber optic cable of claim 14, wherein the partitions deform without breaking or collapsing.
